(19) United States
(12) Patent Application Publication
(10) Pub. No.: US 2003/0137922 A1
(43) Pub. Date: Jul. 24, 2003

(54) Method of manufacturing optical disk

(75) Inventors: Myong-do Ro, Gyeonggi-do (KR); De heen Chang, Seoul (KR); In-sik Park, Gyeonggi-do (KR); Du-seop Yoon, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd, Suwon-city (KR)

(21) Appl. No.: 10/331,934

(22) Filed: Dec. 31, 2002

(30) Foreign Application Priority Data
Jan. 19, 2002 (KR) 2002-3191

(51) Int. Cl. G11B 7/26; B29D 11/00

(52) U.S. Cl. 369/283; 264/1.33; 264/1.7; 264/338; 264/310; 264/1.38

(57) ABSTRACT

A method of manufacturing an optical disk includes spin-coating a substrate with a resin to form a light transmission layer without an additional cover. A spindle jig, which has a central shaft and is formed of a non-adhesive substance, is prepared. A resin is discharged on a surface of the spindle jig. The substrate is placed on the resin so that a recording layer of the substrate faces the spindle jig, and the substrate is spun to form the light transmission layer from the resin. The substrate, which is coated with the light transmission layer, is separated from the spindle jig. Accordingly, the resin is discharged not on a center of the substrate but around the center of the substrate. Thus, the additional cover is unnecessary, and thus a process of manufacturing the optical disk is simplified. Also, an entire surface of the substrate can be uniformly coated with the light transmission layer using the spindle jig and/or a dummy substrate formed of non-adhesive substances.

### CROSS-REFERENCE TO RELATED APPLICATIONS

This application claims the priority of Korean Patent Application No. 2002-3191 on filed Jan. 19, 2002, in the Korean Intellectual Property Office, the disclosure of which is incorporated herein in its entirety by reference.

### BACKGROUND OF THE INVENTION

1. Field of the Invention

The present invention relates to a method of manufacturing an optical disk, and more particularly, to a method of manufacturing an optical disk in which a light transmission layer can be uniformly spin-coated without an additional cover covering a central hole of the optical disk.

2. Description of the Related Art

Optical disks (discs) are generally adopted as information storage media which can be written on and/or read from in a non-contact manner. The optical disks are divided into compact disks (CDs) and digital versatile disks (DVDs) according to an information storage capacity. Recently, as the DVDs have to store a large amount of information, a study of high density and large capacity of DVDs as the information recording media has been briskly made.

A thickness of a substrate of a disk has to be reduced to increase a recording density of the disk and reduce aberration of the disk. Thus, a total thickness of a DVD is maintained to be 1.2 mm, which is equal to a thickness of an existing CD, so as to be compatible with the CD. Here, the DVD is formed with two substrates each having a thickness of 0.6 mm and being attached to each other. Also, the DVD having two or three pieces has been manufactured by stacking two or three thin substrates each having a thickness of 0.3 or 0.4 mm to meet the demands for high density disks.

Further, as shown in FIGS. 1A and 1B, an optical disk includes a substrate 100 having a central hole 105 and a light transmission layer 110. A thickness t of the substrate 100 is 1.1 mm, and a thickness d of the light transmission layer 110 is 0.1 mm so as to maintain a total thickness of the disk to be 1.2 mm. The light transmission layer 110 having the thickness d of 0.1 mm is manufactured by a spin-coating method. Referring to FIG. 1A, an apparatus for spin-coating the light transmission layer 110 on the substrate 100 includes a cover 113 which is inserted into the central hole 105, a spindle 115 which supports the cover 113 and spins the substrate 100, and a spinning support 112 which supports the substrate 100 that spins. A fixing unit 113a having a diameter larger than that of the central hole 105 is placed on the cover 113 to fix the substrate 100 when the cover 113 is inserted into the central hole 105.

During coating the light transmission layer 110 using the apparatus having the above-described structure, the cover 113 is inserted into the central hole 105 to fix the substrate 100 on the spindle 115. A UV-curable resin 107 is discharged on a center portion of the cover 113 using a discharger 117. When a spindle motor (not shown) spins the substrate 100, the UV-curable resin 107 spreads out in a radial direction of the substrate 100 by a centrifugal force and coats an entire surface of the substrate 100. Thereafter, an ultraviolet ray is radiated to cure the UV-curable resin 107 so as to form the light transmission layer 110. The cover 113 is removed after the entire surface of the substrate 100 is coated with the light transmission layer 110.

Here, the fixing unit 113a protrudes on the substrate 100 when the cover 113 is inserted into the central hole 105. Thus, as shown in FIG. 1B, after the spin-coating is completed, and the cover 113 and the fixing unit 113a are removed from the disk, a protrusion 110a is formed due to the fixing unit. The protrusion 110a has a thickness of 30-60 μm, compared to the other portions of the light transmission layer 110, which causes a great deviation when the disk spins to record/reproduce information on/from the disk, thereby causing a poor data recording/reproducing performance.

The UV-curable resin 107 is a polymer, which is a viscoelastic substance. Here, elasticity refers to a property which the polymer restores to its original shape by Hooke's Law when a stress is removed after the polymer is deformed by stress. Thus, when the light transmission layer 110 is formed by the spin-coating, a bump 110b is created on an outer circumference of the disk due to the elasticity of the UV-curable resin 107 after the substrate 100 stop spinning at a high speed. When ultraviolet rays are radiated onto the resin 107, the resin 107 hardens to form the bump 110b. Thus, a region of the disk in which information can be recorded is reduced by a width w of the bump 100b on the disk circumference. FIG. 2 is a graph showing a test result in which changes in the width of the bump 110b are measured with respect to the thickness of the light transmission layer 110. In this graph, a horizontal axis represents the thickness d of the light transmission layer 110, and a vertical axis represents the width w of the bump 110b. It can be seen that the width w of the bump 110b is greater than 1.5 mm around a 100 μm thickness of the light transmission layer 110. Thus, a sum of each width w of bumps 110b disposed to be diametrically opposite to each other with respect to the central hole 105 accounts for 3 mm or more of a diameter of the disk. Therefore, a data recording capacity is reduced by double the width w of the bump 110b.

As a consequence, various methods of removing the bump 110b have been applied. One of them is to prevent the bump 110 from being created by blowing an air flow from an inner circumference of the substrate 100 to the outer circumference so as to planarize the UV-curable resin before the UV-curable resin hardens. However, in this case, a surface of the UV-curable resin may become nonuniform.

Another method is to trim the bump 110b with a trimmer 125 while a spinning unit 120 spins the substrate 100 as shown in FIG. 3. However, in this case, it takes too long to trim the bump 110b, and minute dust occurs when trimming contaminates a surface of the substrate 100, thereby deteriorating recording/reproducing characteristics of the disk.

As described above, when the light transmission layer 110 is formed, an additional unit, such as the cover 113, is necessary to discharge the UV-curable resin on a center of the substrate 100. Thus, a process of manufacturing the disk is complicated, and a cost of manufacturing the disk increases. Also, the use of the cover 113 creates the protrusion 110a on a center of the disk, and due to the protrusion 110a, the disk deviates from a drive when the disk spins after being mounted in the drive, thus causing the poor data recording/reproducing performance. Further, a subsequent manufacturing step is necessary to remove the bump 110b created on the circumference of the disk, and thus the process of manufacturing the disk is complicated.

### SUMMARY OF THE INVENTION

To solve the above and/or other problems, it is an aspect of the present invention to provide a method of manufacturing an optical disk by which a uniform light transmission layer of the optical disk is formed through spin-coating using a spindle jig formed of a non-viscous substance that eliminates the need of a cover and prevents a bump from being created on a circumference of the transmission layer of the optical disk.

Additional aspects and advantages of the invention will be set forth in part in the description which follows and, in part, will be obvious from the description, or may be learned by practice of the invention.

Accordingly, to achieve the above and/or other aspects, there is provided a method of manufacturing an optical disk. A spindle jig, which has a central shaft and is formed of a non-adhesive substance, is prepared. A resin is discharged on a surface of the spindle jig. A substrate is placed on the resin so that a recording layer of the substrate faces the spindle jig, and the substrate is spun to form a light transmission layer. The substrate, which is coated with the light transmission layer, is separated from the spindle jig.

The non-adhesive substance is Teflon-S, PIFA, Teflon PTFE, or FEP. The surface of the spindle jig is coated with the non-adhesive substance. The resin is discharged around the central shaft of the spindle jig.

To achieve the above and/or aspects, there is provided a method of manufacturing an optical disk. A spindle jig, which has a central shaft and is formed of a non-adhesive substance, and a substrate having a recording layer are prepared. A resin is discharged around a center of the substrate. The substrate is placed on the spindle jig so that the recording layer faces the spindle jig, and the substrate is spun to form a light transmission layer. The substrate, which is coated with the light transmission layer, is separated from the spindle jig.

To achieve the above and/or other aspects, there is provided a method of manufacturing an optical disk. A substrate having a recording layer is placed on a spindle jig, and a resin is discharged on the substrate. A dummy substrate formed of a non-adhesive substance through which light is transmitted is put on the substrate on which the resin is discharged, and the substrate is spun to form a light transmission layer. The dummy substrate is removed from the light transmission layer.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIGS. 1A and 1B are cross-sectional views of a conventional optical disk explaining a method of manufacturing the conventional optical disk;

FIG. 2 is a graph showing changes in a width of a bump with respect to a thickness of a light transmission layer;

FIG. 3 is a cross-sectional view of an apparatus for removing a bump of the optical disk shown in FIGS. 1A and 1B;

FIGS. 4A through 4E are cross-sectional views illustrating a process of manufacturing an optical disk according to an embodiment of the present invention;

FIGS. 5A through 5E are cross-sectional views illustrating a process of manufacturing an optical disk according to another embodiment of the present invention; and

FIGS. 6A through 6E are cross-sectional views illustrating a process of manufacturing an optical disk according to another embodiment of the present invention.

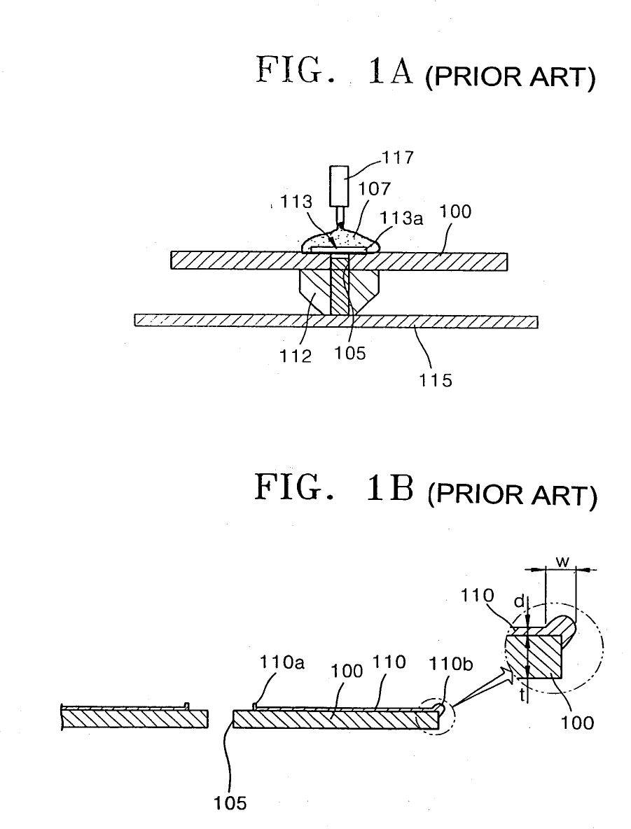

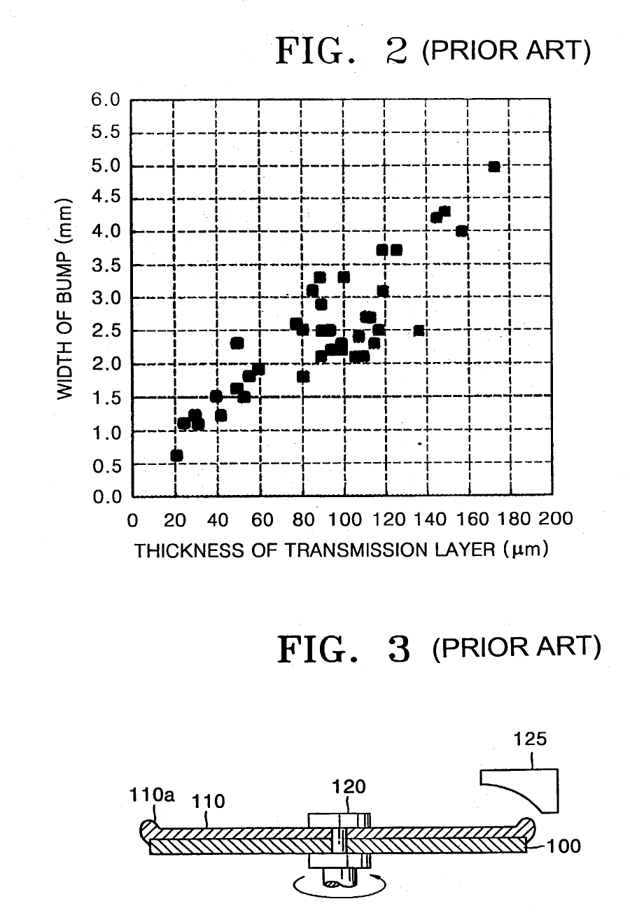

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

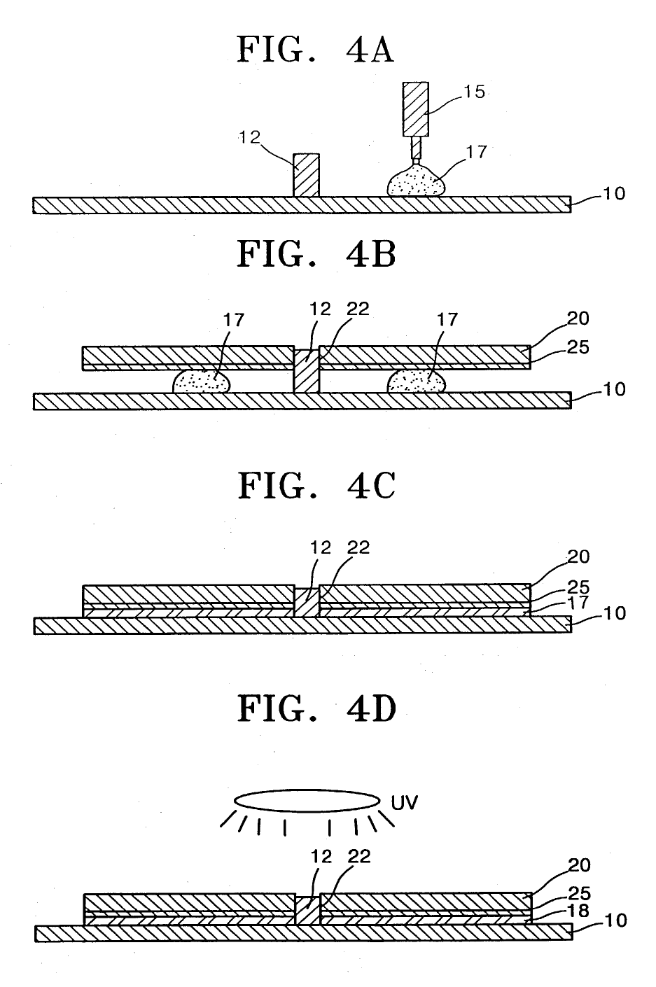

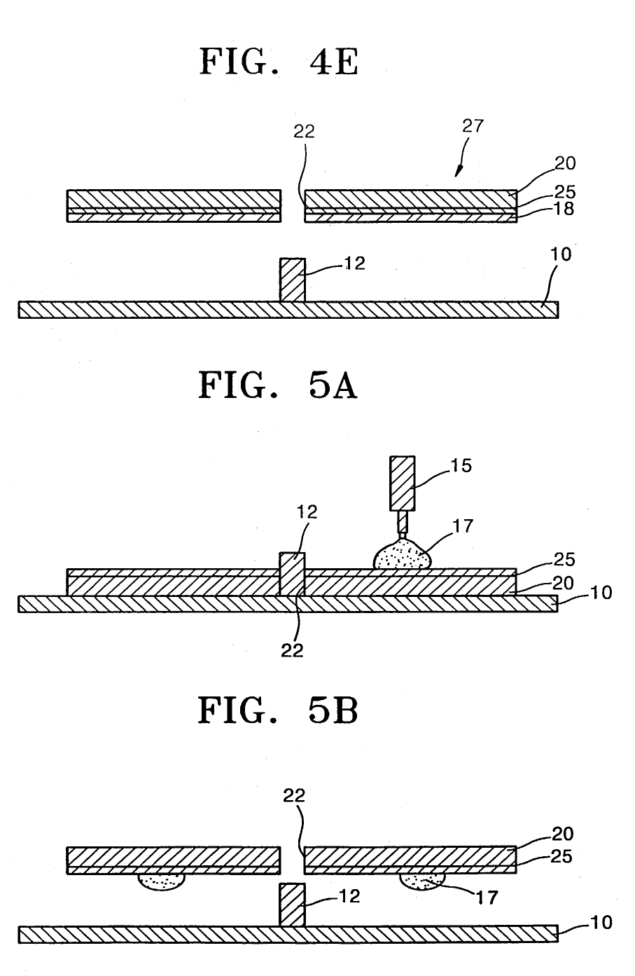

Referring to FIGS. 4A through 4E, in a method of manufacturing an optical disk 27 according to an embodiment of the present invention, a resin 17 is discharged on a surface of a spindle jig 10 from which a shaft 12 protrudes. A substrate 20 having a recording layer 25 is disposed over the spindle jig 10 so that the recording layer 25 contacts the resin 17. Here, it is possible that the resin 17 is discharged around the shaft 12. Thereafter, the substrate 20 is spun at a high speed so that the resin 17 to uniformly fills a gap between the substrate 20 and the spindle jig 10 to coat the recording layer 25 with the resin 17. The substrate 20 may rotate together with the spindle jig 10.

As shown in FIGS. 4B and 4C, a distance between the spindle jig 10 and the substrate 20 varies during a rotation of the substrate 20. The distance is reduced until a thickness of the resin 17 becomes a predetermined thickness to uniformly form the light transmission layer 18. One of the spindle jig 10 and the substrate 20 does not move toward the other one of the spindle jig 10 and the substrate 20.

A central hole 22 is formed in the substrate 20. The shaft 12 is inserted into the central hole 22 to mount the substrate 20 on the spindle jig 10. As shown in FIG. 4D, ultraviolet (UV) rays are radiated onto the substrate 20 to form a light transmission layer 18 by curing the resin 17 of FIG. 4C.

It is possible that the spindle jig 10 is formed of a fluorine resin-based substance having a large non-adhesiveness. For example, it is possible that the spindle jig 10 is formed of a Teflon-based substance. The Teflon-based substance has special chemical and physical characteristics that a high polymer does not have. The Teflon-based substance includes polytetrafluoethylene (PTFE), fluorinated ethylene propylene copolymer (FEP), and/or perfluoroalkoxy (PFA). Since Teflon has the large non-adhesiveness, almost all substances do not adhere to the Teflon. Substances having even a strong adhesiveness are also easily separated from the Teflon. A friction coefficient of the Teflon depends on load, sliding speed, and the kinds of coating, and is generally between about 0.05-0.20. Since water or oil does not adhere well onto a surface which is coated with the Teflon, it is easy to clean the surface. In many cases, a cleanliness of the surface is naturally maintained. The coating of the Teflon is performed at a temperature of up to 290° C. (550° F.), and may be performed at the temperature of up to maximum 315° C. (600° F.) under a properly managed condition.

The Teflon has a high insulation characteristic over a wide frequency bandwidth, a low loss rate, and a high surface resistance. Also, the Teflon can be endowed with conductivity by a special technique and can be used as an anti-static coating substance. Also, when the Teflon is coated at an extremely low temperature, the Teflon does not lose its physical characteristics. A lowest temperature for coating the Teflon is −270° C. (−454° F.).

Teflon-based substances having the above-described characteristics are shown in table 1. One of the Teflon-based substances may be selected from table 1 in consideration of characteristics that the spindle jig 10 requires.

Referring to table 1, the spindle jig 10 is formed with one of Teflon-S, PIFA, PTFE, and FEP, or the spindle jig 10 formed of a general substance is coated with one of Teflon-S, PIFA, PTFE, and FEP. In particular, it is possible that the spindle jig 10 is formed of PTFE or FEP.

TABLE 1

| Required Characteristic | Good | Better | Best |
|---|---|---|---|
| Chemical resistance | Teflon-S | ETFE, FEP | PFA |
| Corrosion resistance | FEP | Teflon-S | Teflon-S |
| Abrasion resistance | PTFE | Teflon-S | ETFE, PRA |
| Heat resistance | Teflon-S | FEP | PTFE, PFA |
| Non adhesiveness | Teflon-S | PIFA | PTFE, FEP |

As shown in FIG. 4E, a disk 27 which is coated with the light transmission layer 18 is separated from the spindle jig 10 through the above-described process. Here, since the spindle jig 10 is formed of a Teflon-based substance having a good non-adhesiveness, the disk 29 can be separated from the spindle jig 10 without damaging the light transmission layer 18 of the disk.

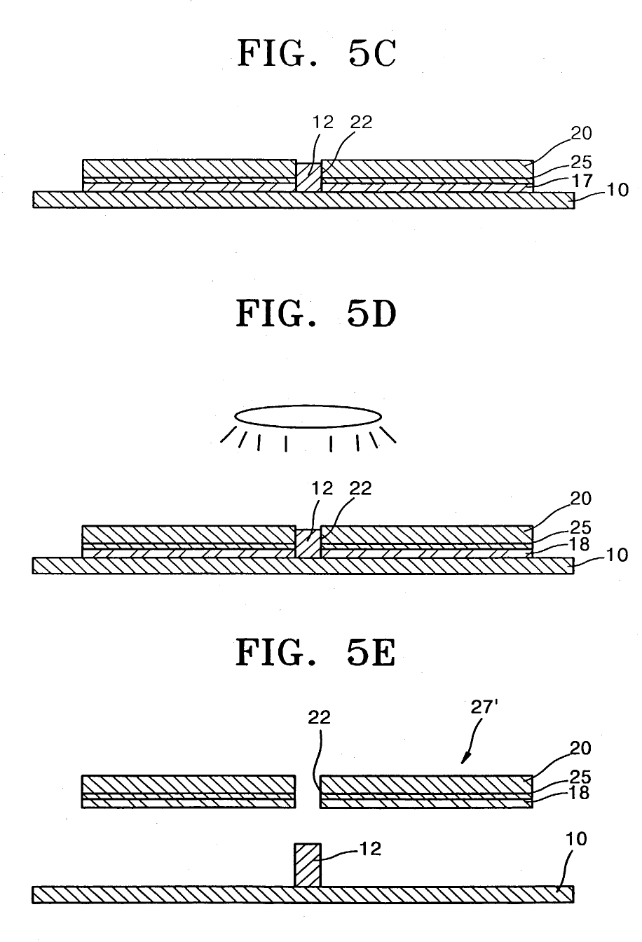

Referring to FIGS. 5A through 5D, in a method of manufacturing an optical disk 27′ according to another embodiment of the present invention, the substrate 20 is placed on the spindle jig 10 so that the recording layer 25 faces upward. After the resin 17 is discharged on the substrate 20, the substrate 20 is reversed and mounted on the spindle jig 10. Thereafter, the substrate 20 is spun so that the resin 17 is uniformly coated on the recording layer 25 of the substrate 20, thus forming the light transmission layer 18 as shown in FIG. 5C. As shown in FIGS. 5D and 5E, an operation of curing the resin 17 by radiating UV rays thereon and another operation of separating the completed optical disk 27′ from the spindle jig 10 are the same as those described in FIGS. 4D and 4E.

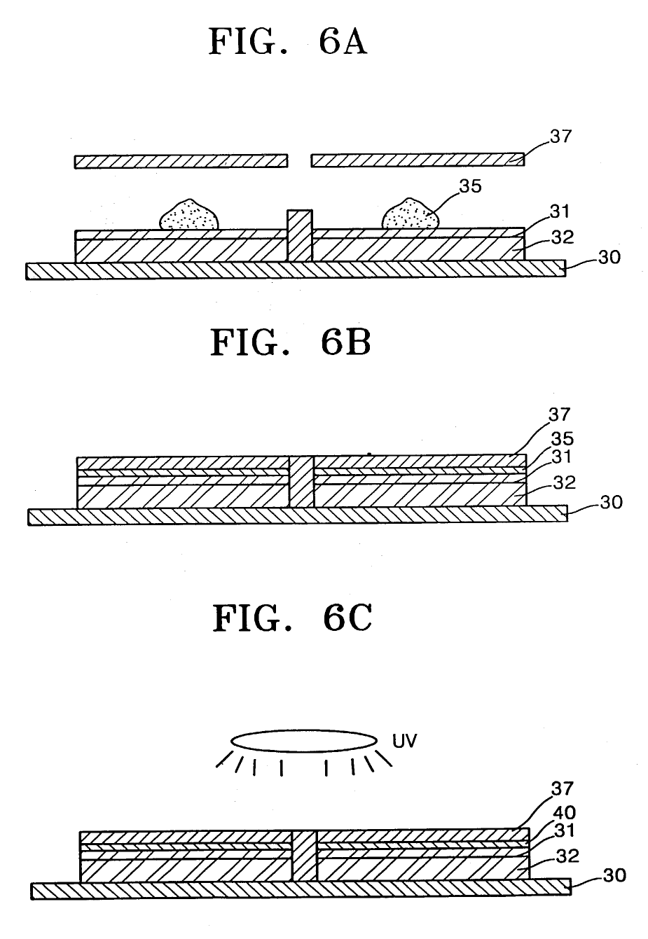

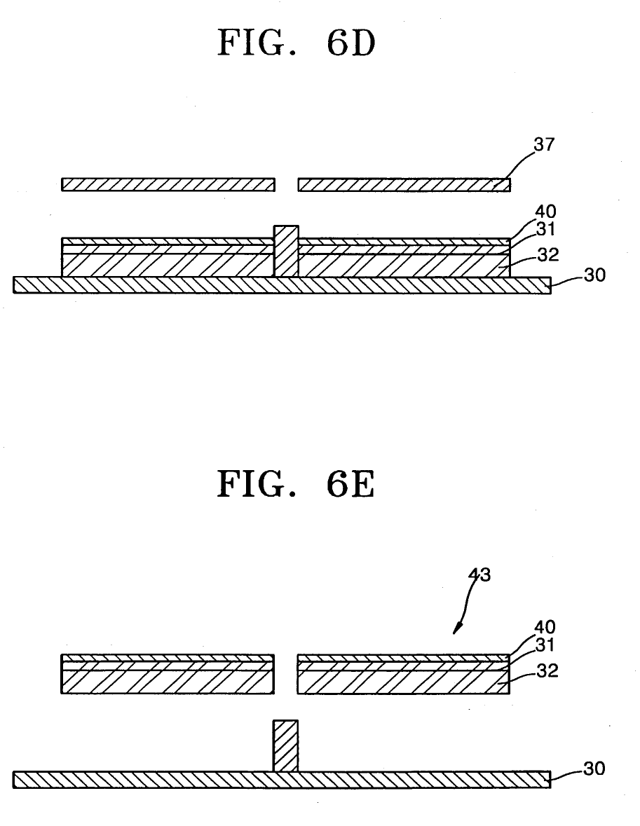

Referring to FIGS. 6A through 6E, in a method of manufacturing an optical disk 43 according to another embodiment of the present invention, a substrate 32 having a recording layer 31 is placed on a spindle jig 30. A resin 35 is discharged on the substrate 32. Here, it is possible that the resin 35 is discharged around a center of the substrate 32. The spindle jig 30 does not need to be formed of a non-adhesive substance. A dummy substrate 37 is disposed on the substrate 32 having the resin 35 thereon and spun with the substrate 32 so as to coat the substrate 32 with the resin 35 to form a light transmission layer 40. It is possible that the dummy substrate 37 is formed of a non-adhesive substance through which light can be transmitted.

The UV rays are radiated onto the dummy substrate 37 to cure the light transmission layer 40, and then the dummy substrate 37 is removed from the light transmission layer 40 of the substrate 32. Here, since the dummy substrate 37 is formed of the non-adhesive substance, the light transmission layer 40 is not damaged when the dummy substrate 37 is removed from the light transmission layer 40. The disk 43, which is completed through the above-described process, is separated from the spindle jig 30. In this embodiment, the substrate 32 is directly placed on the spindle jig 30, and the light transmission layer 40 is spin-coated between the substrate 32 and the dummy substrate 37. Thus, the spindle jig 30 does not need to have a non-adhesive characteristic.

Although the light transmission layer 18, 40 is formed on the recording layer 25, 31, the invention is not limited thereto. The light transmission layer 18, 40 may be formed on an intermediate layer, which is formed on the recording layer 25, 31 to protect the recording layer 25, 31 or to improve a recording efficiency and reflectivity of the recording layer 25, 31.

According to the present invention, in a method of manufacturing an optical disk, when manufacturing a light transmission layer, resin is discharged not on a center of a substrate but around the center of the substrate. Thus, an additional cover is unnecessary, and thus a process of manufacturing the optical disk is simplified. Also, an entire surface of the substrate can be uniformly coated with the light transmission layer using a spindle jig and a dummy substrate formed of better non-adhesive substances. Furthermore, when spinning the resin, the spindle jig or the dummy substrate serves to cover the resin. Thus, a bump is not created on an outer circumference of the substrate, and the substrate can be uniformly coated with the resin.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. A method of manufacturing an optical disk comprising:
discharging a resin on a surface of a spindle jig having a central shaft and formed of a non-adhesive substance;
placing a substrate having a recording layer on the discharged resin so that the recording layer of the substrate faces the spindle jig;
spinning the substrate to form a light transmission layer from the resin; and
separating the substrate which is coated with the light transmission layer, from the spindle jig.

2. The method of claim 1, wherein the non-adhesive substance is one of Teflon-S, PIFA, Teflon PTFE, and FEP.

3. The method of claim 2, wherein the discharging of the resin comprises:
discharging the resin around the central shaft of the spindle jig.

4. The method of claim 2, wherein the surface of the spindle jig is coated with the non-adhesive substance.

5. The method of claim 4, wherein the discharging of the resin comprises:
discharging the resin around the central shaft of the spindle jig.

6. A method of manufacturing an optical disk comprising:
discharging a resin around a center of a substrate having a recording layer;
placing the substrate on a spindle jig having a central shaft and formed of a non-adhesive substance so that the recording layer of the substrate faces the spindle jig;
spinning the substrate to form a light transmission layer from the resin; and
separating the substrate which is coated with the light transmission layer, from the spindle jig.

7. The method of claim 6, wherein the non-adhesive substance is one of Teflon-S, PIFA, Teflon PTFE, and FEP.

8. A method of manufacturing an optical disk comprising:
placing a substrate having a recording layer on a spindle jig;
discharging a resin on the substrate;
positioning a dummy substrate formed of a non-adhesive substance through which light is transmitted, on the substrate on which the resin is discharged;
spinning the substrate to form a light transmission layer from the resin; and
removing the dummy substrate from the substrate.

9. The method of claim 8, wherein the discharging of the resin comprises:
discharging the resin around a center of the substrate.

10. The method of claim 8, wherein the positioning of the dummy substrate on the substrate comprises:
causing the dummy substrate to be parallel to the substrate.

11. The method of claim 8, wherein the dummy substrate has a diameter equal to or greater than that of the substrate so that the resin covers the substrate with a substantially uniform thickness throughout a surface of the substrate.

12. The method of claim 8, wherein the removing of the dummy substrate comprises:
curing the resin disposed between the dummy substrate and the substrate using a UV ray.

13. The method of claim 8, wherein a surface of the dummy substrate is formed of a non-adhesive material.

14. The method of claim 13, wherein the material comprises:
one of polytetrafluoethylene (PTFE), fluorinated ethylene propylene copolymer (FEP), and/or perfluoroalkoxy (PFA).

15. The method of claim 13, wherein the material comprises:
one of a Teflon-based substance, a fluorine resin-based substance, and an anti-static coating substance.

16. The method of claim 13, wherein the material has conductivity.

17. A method of manufacturing an optical disk, the method comprising:
causing a resin to be disposed between a plate and a substrate having a recoding layer;
rotating the substrate to form a light transmission layer between the plate and the substrate from the resin; and
separating the plate from the light transmission layer of the substrate.

18. The method of claim 17, wherein a surface of the plate is formed of a non-adhesive material.

19. The method of claim 18, wherein the material comprises:
one of polytetrafluoethylene (PTFE), fluorinated ethylene propylene copolymer (FEP), and/or perfluoroalkoxy (PFA).

20. The method of claim 18, wherein the material comprises:
one of a Teflon-based substance, a fluorine resin-based substance, and an anti-static coating substance.

21. The method of claim 17, wherein the positioning of the plate on the substrate comprises:
causing the plate to be parallel to the substrate.

22. The method of claim 17, wherein the plate has a diameter equal to or greater than that of the substrate.

23. The method of claim 17, wherein the rotating of the substrate comprises:
covering all surfaces of the substrate with the resin.

24. The method of claim 17, wherein the rotating of the substrate comprises:
forming the resin to have a substantially uniform thickness throughout a surface of the substrate.

25. The method of claim 17, wherein the removing of the plate comprises:
curing the resin disposed between the plate and the substrate using a UV ray.

26. The method of claim 17, wherein the plate is transparent, and the removing of the plate comprises:
radiating a UV ray on the resin through the plate.

27. The method of claim 17, wherein the plate comprises:
one of a spindle jig and a dummy substrate each formed with a non-adhesive material.

28. The method of claim 17, wherein the causing of the resin to be disposed between a substrate and a plate comprises:
discharging the resin on a surface of the substrate.

29. The method of claim 28, wherein the causing of the resin to be disposed between a substrate and a plate comprises:
covering the resin with the plate after the resin is discharged on the substrate.

30. The method of claim 17, wherein the substrate comprises a central hole, and the discharging of the resin comprises:
discharging the resin a first portion of the substrate other than a second portion corresponding to the central hole.

31. The method of claim 30, wherein the plate comprises a shaft, and the causing a resin to be disposed between the plate and the substrate comprises:
inserting the shaft of the plate into the central hole of the substrate.

32. The method of claim 31, wherein the shaft of the plate has a thickness is greater than that of the resin disposed between the plate and the substrate in a direction parallel to the a shaft of the plate.

33. The method of claim 31, wherein and the causing a resin to be disposed between the plate and the substrate comprises:
discharging the resin on one of the plate and the substrate.

34. The method of claim 32, wherein the discharging of the resin comprises:
discharging the resin around the shaft of the plate.

35. The method of claim 32, wherein the discharging of the resin comprises:
discharging the resin before the shaft of the plate is inserted into the central hole of the substrate.

36. The method of claim 17, wherein the discharging of the resin comprises:
positioning the plate above the substrate so that the resin is disposed between the plate and the substrate.

37. The method of claim 17, wherein the causing of the resin comprises:
discharging the resin on a surface of the plate.

38. The method of claim 37, wherein the discharging of the resin comprises:
positioning the substrate above the substrate so that the resin is disposed between the substrate and the spindle jig.

39. The method of claim 17, wherein the rotating of the substrate comprises:
moving the plate toward the substrate.

40. The method of claim 17, wherein the rotating of the substrate comprises:
reducing a distance between the plate and the substrate to cause the resin to have a thickness corresponding to the light transmission layer.

41. The method of claim 17, wherein the plate is coupled to a rotation source, and the rotating of the substrate comprises:
rotating the substrate and the plate together.

42. The method of claim 17, wherein the substrate comprises a central hole and a major surface, and the rotating of the substrate comprises:
forming the light transmission layer having the same surface area as the major surface of the substrate.

43. The method of claim 42, wherein light transmission layer comprises an outer surface corresponding to the major surface of the substrate, and the forming of the light transmission layer comprises:
maintaining the outer surface of the light transmission layer to be parallel to the major surface of the substrate during maintaining the plate to be parallel to the major surface of the substrate.

44. An optical disk, comprising:
a substrate having a central hole and a major surface;
a recording layer formed on the major surface of the substrate except a portion corresponding to the central hole; and
a light transmission layer formed on the recording layer except the portion corresponding to the central hole of the substrate, and having a surface having the same area as the major surface of the substrate and being parallel to the major surface of the substrate to cover the recording layer without one of a cutout portion and a trimmed portion.
